(19) United States
(12) Patent Application Publication
(10) Pub. No.: US 2011/0055294 A1
(43) Pub. Date: Mar. 3, 2011

(54) CELLULAR TERMINAL DEVICE, E-MAIL DELETION METHOD, AND RECORDING MEDIUM

(75) Inventors: Makiko Noma, Kawasaki (JP); Mikimasa Yamagishi, Kawasaki (JP); Manabu Kondo, Kawasaki (JP); Hiroshi Yamashita, Kawasaki (JP)

(73) Assignee: FUJITSU LIMITED, Kawasaki (JP)

(21) Appl. No.: 12/851,134

(22) Filed: Aug. 5, 2010

(30) Foreign Application Priority Data
Sep. 3, 2009 (JP) 2009-204073

(51) Int. Cl. G06F 17/30

(52) U.S. Cl. 707/813; 707/E17.005

(57) ABSTRACT

A cellular terminal device including a memory for storing a received e-mail, a deletion order determiner for determining a deletion order of a plurality of e-mails stored on the memory based on an operation of a user or history information related to a mail sender and a deletion processor for deleting an e-mail stored on the memory in accordance with the deletion order determined by the deletion order determiner.

### CROSS-REFERENCE TO RELATED APPLICATIONS

This application is related to and claims priority to Japanese Patent Application No. 2009-204073 filed on Sep. 3, 2009 and herein incorporated by reference.

### FIELD

Various embodiments described herein relate to a cellular terminal device, an electronic mail (e-mail) deletion method, and a recording medium.

### BACKGROUND

A cellular terminal device such as a cellular phone in a typical operation thereof may receive an e-mail, and store the received e-mail on a storage area called a received mail box. If no memory space is available in the mail box, no e-mail can be stored on the mail box. In such a case, an e-mail having the oldest reception time and date in the mail box is deleted to make a memory space, and a newly received e-mail is then stored on the received mail box.

If the mails are successively deleted in the order of reception from old to new, an e-mail that should not be deleted can be from time to time deleted. To avoid this situation, a user may perform a complicated operation for protecting important mails. If the user forgets protecting an important e-mail, that important e-mail is deemed to be automatically deleted.

In a related art technique, an e-mail sorted to a particular folder is deleted with a higher priority in order to overcome the problem that an important e-mail is automatically deleted. If an e-mail of the kind that the deletion thereof presents no problem is set to be sorted to the particular folder, unwanted e-mails can be automatically deleted with a higher priority.

In a proposed related art technique, a priority is attached to each e-mail in accordance with a condition set by the user, and a low-priority e-mail is deleted with a higher priority. The set condition here refers to a map of priority to a transmission source address of an e-mail, for example. In accordance with the related art technique, the priority of the transmission source address as a deletion target is set to be lower such that an automatic and unintended deletion of an important e-mail is prevented. For example, Japanese Laid-open Patent Publication No. 2006-235841, Japanese Laid-open Patent Publication No. 2002-278896, Japanese Laid-open Patent Publication No. 2006-134200, and Japanese Laid-open Patent Publication No. 2008-152578 are known as related art.

Each of the above-described related art techniques causes the user to be conscious of “which e-mail is to be deleted.” The user needs to pay attention to each e-mail.

With the typical technique of sorting the e-mails to a particular folder, the user needs to determine whether to sort each e-mail to the particular folder. With the typical technique of attaching the priority to the e-mail in accordance with the uniformly set condition, the user needs to determine how the priority of a sender address is to be set.

### SUMMARY

It is an aspect of the embodiments discussed herein to provide a cellular terminal device including a memory for storing a received e-mail, a deletion order determiner for determining a deletion order of a plurality of e-mails stored on the memory based on an operation of a user or history information related to a mail sender and a deletion processor for deleting an e-mail stored on the memory in accordance with the deletion order determined by the deletion order determiner.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates a structure of a cellular terminal device of an embodiment.

FIG. 2 illustrates a structure of a cellular terminal device of an embodiment.

FIG. 3 illustrates an operation trend information storage unit.

FIG. 4 illustrates a related information storage unit.

FIG. 5 illustrates a received mail storage unit.

FIG. 6 is a flowchart illustrating an operation trend information gathering process of the operation trend information gatherer illustrated in FIG. 2.

FIG. 7 is a flowchart illustrating a mail check process of a received mail checking unit illustrated in FIG. 2.

FIG. 8 is a flowchart illustrating a manual protection information gathering process of a manual protection information gathering unit illustrated in FIG. 2.

FIG. 9 is a flowchart illustrating a deletion order determination process of a deletion order determiner illustrated in FIG. 2.

FIG. 10 is a flowchart illustrating a deletion process of a deletion processor illustrated in FIG. 2.

FIG. 11 illustrates a structure of a cellular terminal device of an embodiment.

FIG. 12 illustrates an operation trend information storage unit.

FIG. 13 illustrates a related information storage unit.

FIG. 14 is a flowchart illustrating an operation trend information gathering process of an operation trend information gatherer illustrated in FIG. 11.

FIG. 15 is a flowchart illustrating a manual deletion information gathering process of a manual deletion information gathering unit illustrated in FIG. 11.

FIG. 16 is a flowchart illustrating a mail view information gathering process of a mail view information gathering unit illustrated in FIG. 11.

FIG. 17 is a flowchart illustrating an cellular terminal device internal information gathering process of a cellular terminal internal information gathering unit.

FIG. 18 illustrates an e-mail deletion process.

FIG. 19 illustrates a computer executing a cellular terminal control program.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

A cellular terminal device, an e-mail deletion method, and a recording medium to be disclosed in the application are described in detail below with reference to the drawings. The cellular terminal device, the e-mail deletion method, and the recording medium are not limited to the embodiments described herein.

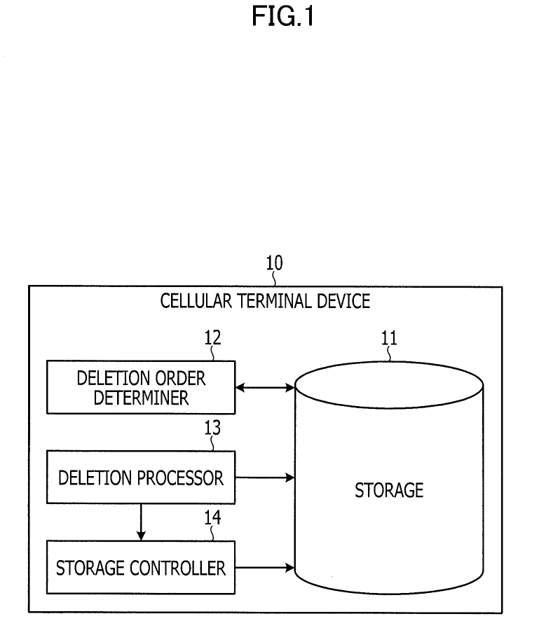

A structure of a cellular terminal device 10 of an embodiment is described below with reference to FIG. 1. FIG. 1 illustrates the structure of the cellular terminal device 10. Referring to FIG. 1, the cellular terminal device 10 has a function of receiving an e-mail. Upon receiving an e-mail, the cellular terminal device 10 stores the received e-mail on a specific storage area. If the cellular terminal device 10 of an embodiment receives an e-mail with no memory space available for the e-mail, the cellular terminal device 10 automatically deletes from the specific storage area an e-mail that is likely to become unnecessary for the user. Elements of the cellular terminal device 10 are described below in detail.

Referring to FIG. 1, the cellular terminal device 10 of an embodiment includes a storage 11, a deletion order determiner 12, a deletion processor 13, and a storage controller 14. The storage 11 stores a received e-mail. A size of an e-mail the storage 11 can store is typically specified. For example, a number of e-mails to be stored on the storage 11 is specified or a total size of e-mails to be stored on the storage 11 is specified.

The deletion order determiner 12 determines a deletion order of a plurality of e-mails stored on the storage 11 in accordance history information of operation(s) of a user or history information about a relation between the user and a sender of the e-mail stored on the storage 11. More specifically, the deletion order determiner 12 determines the deletion order of e-mails likely to become unnecessary for the user in accordance with the history information. The determination of the deletion order may be based on a plurality of factors relating to history information including that pertains to the user and/or use of the cellular terminal device 10.

If a new e-mail is received with no memory space available on the storage 11, the deletion processor 13 performs a deletion process to delete an e-mail stored on the storage 11 in the deletion order determined by the deletion order determiner 12. After the deletion processor 13 performs the deletion process, the storage controller 14 stores a newly received e-mail on the storage 11.

The cellular terminal device 10 of an embodiment determines the deletion order of a plurality of e-mails stored on the storage 11 in response to an operation of the user or the history information about the relation between the user and the mail sender. When a new e-mail is received, the cellular terminal device 10 performs the deletion process on the e-mail stored on the storage 11 in accordance with the deletion order, and stores the new e-mail on the storage 11. The cellular terminal device 10 of an embodiment automatically deletes the e-mails in an order according to which the e-mails are likely to become unnecessary for the user.

The cellular terminal device 10 of an embodiment dynamically determines the deletion order of the e-mails in accordance with the operation history of the user. The e-mails likely to become unnecessary for the user are efficiently deleted without the need for the user to be conscious of the e-mail as an automatic deletion target.

The cellular terminal device of an embodiment is specifically discussed. In accordance with an embodiment, information related to an e-mail deleted by the user and information related to an e-mail protected by the user are used as history information.

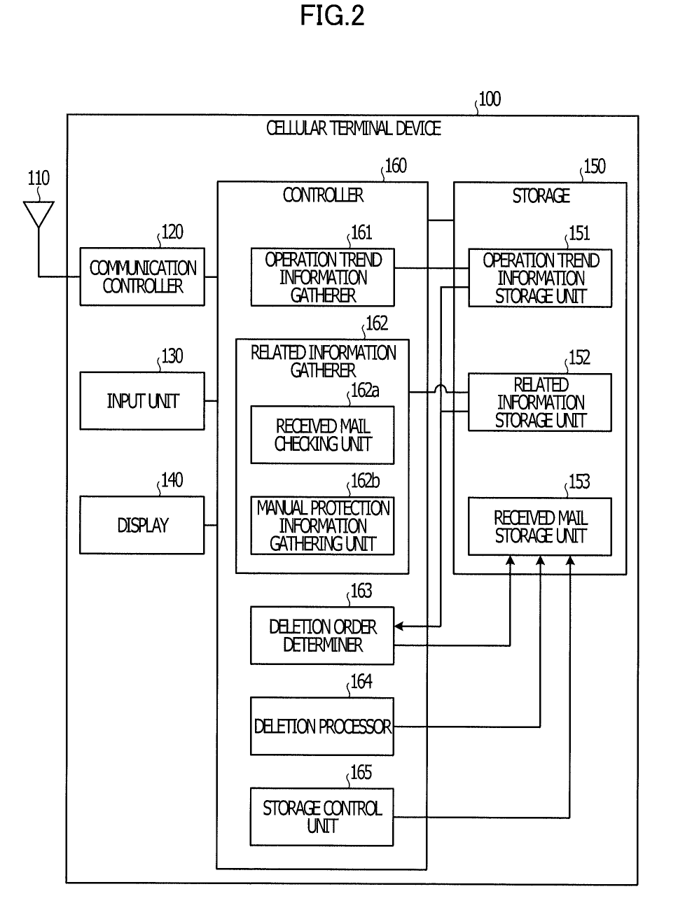

((Structure of the Cellular Terminal Device of an Embodiment)) Referring to FIG. 2, a structure of a cellular terminal device 100 of an embodiment is described below. FIG. 2 illustrates the structure of the cellular terminal device 100 of an embodiment. The cellular terminal device 100 of an embodiment is a cellular telephone or a personal digital assistant (PDA), for example. Referring to FIG. 2, the cellular terminal device 100 includes an antenna 110, a communication controller 120, an input unit 130, a display 140, a storage 150, and a controller 160.

The antenna 110 transmits a signal to and receives a signal from the outside. For example, the antenna 110 transmits an e-mail to and receives an e-mail from an external information process apparatus. The communication controller 120 performs communication control on voice communication and data communication via a base station (not illustrated).

The input unit 130 is an input device for inputting a variety of information and an operation instruction. For example, the input unit 130 includes alphanumerical keys for inputting numbers and characters, and cursor keys for selecting a menu, and for scrolling operations. The display 140 is an output device for outputting a variety of information, and includes a liquid-crystal device, and a loudspeaker.

The storage 150 is a storage device for storing a variety of information. The storage 150 includes a random-access memory (RAM), or a flash memory. Referring to FIG. 2, the storage 150 of an embodiment includes an operation trend information storage unit 151, a related information storage unit 152, and a received mail storage unit 153.

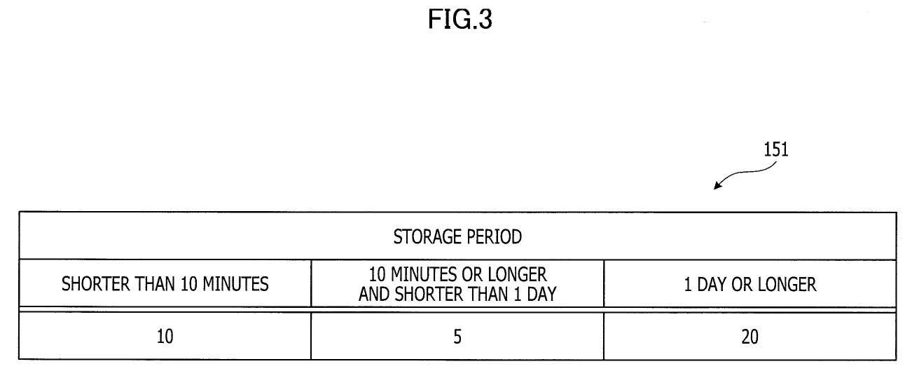

The operation trend information storage unit 151 stores information indicating an operation trend of the user using each e-mail stored on the received mail storage unit 153 (hereinafter referred to as “operation trend information”). FIG. 3 illustrates an example of an operation trend information storage unit 151. The “storage period” stores on a per specific storage period basis the total number of e-mails deleted by the user. Referring to FIG. 3, the storage period is categorized into “shorter than 10 minutes,” “10 minutes or longer and shorter than 1 day,” and “1 day or longer.”

The operation trend information storage unit 151 of FIG. 3 indicates that the number of e-mails that have a storage period “shorter than 10 minutes” from the mail reception of the cellular terminal device 100 to the mail deletion by the user is “10 mails.” The operation trend information storage unit 151 of FIG. 3 indicates that the number of e-mails that have a storage period “10 minutes or longer and shorter than 1 day” from the mail reception of the cellular terminal device 100 to the mail deletion by the user is “5 mails.” The operation trend information storage unit 151 of FIG. 3 indicates that the number of e-mails that have a storage period “longer than 1 day” from the mail reception of the cellular terminal device 100 to the mail deletion by the user is “20 mails.”

In the operation trend information storage unit 151 of FIG. 3, the user of the cellular terminal device 100 tends to delete an e-mail after the elapse of 1 day or longer after mail reception. Moreover in the operation trend information storage unit 151 of FIG. 3, the user of the cellular terminal device 100 is less likely to delete an e-mail that elapsed 10 minutes or longer but not elapsed 1 day from the mail reception. The cellular terminal device 100 can thus identify the trend of the e-mails to be deleted by the user in accordance with a variety of information stored on the operation trend information storage unit 151. While a specific operation trend is illustrated in association with FIG. 3, the present invention is not limited to any particular trend. For example, trend information may be tracked based on any processing of an email received from sender(s) such that a number of particular processing(s) results in the email being indicated for deletion.

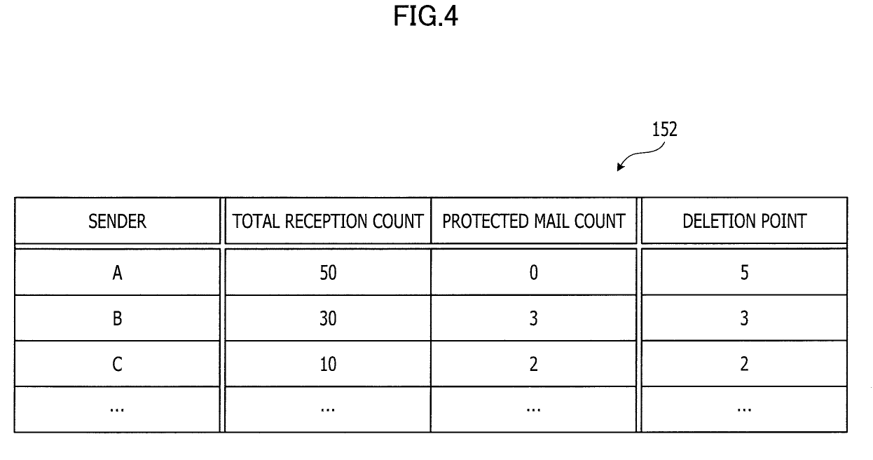

The related information storage unit 152 stores a variety of information indicating the importance of each e-mail for each of the senders having sent the e-mails stored on the received mail storage unit 153. In other words, the related information storage unit 152 stores information related to a mail sender of an e-mail being important for the user. In the discussion that follows, the variety of information to be stored on the related information storage unit 152 is sometimes referred to as “related information.” FIG. 4 illustrates an example of the related information storage unit 152. Referring to FIG. 4, the related information storage unit 152 of an embodiment stores items such as “sender, “total reception count,” “protected mail count,” and “deletion point.”

The “sender” indicates sender information of the e-mail received by the cellular terminal device 100. For example, a transmission source address, and a sender name of a sender are stored at the “sender.” The “total reception count” indicates a number of e-mails transmitted by the “sender” from among the e-mails stored on the cellular terminal device 100. The “protected mail count” indicates the number of e-mails protected by the user from among the corresponding “total reception count.”

The “deletion point” is an indicator that is used to determine the deletion order. The “deletion point” is updated by a deletion order determiner 163. The “deletion point” is described in detail later together with the deletion order determiner 163.

A first row of the related information storage unit 152 illustrated in FIG. 4 indicates that the number of e-mails received from a sender “A” is “50,” and that the number of e-mails protected by the user out of the 50 e-mails is “0.” A second row of the related information storage unit 152 illustrated in FIG. 4 indicates that the number of e-mails received from a sender “B” is “30,” and that the number of e-mails protected by the user out of the 30 e-mails is “3.” A third row of the related information storage unit 152 illustrated in FIG. 4 indicates that the number of e-mails received from a sender “C” is “10,” and that the number of e-mails protected by the user out of the 10 e-mails is “2.”

In the related information storage unit 152 of FIG. 4, the cellular terminal device 100 receives e-mails more from the sender “A” than e-mails from each of the senders “B” and “C.” The user of the cellular terminal device 100 is less likely to protect the e-mails received from the sender “A,” and more likely to protect the e-mails received from the sender “C.” The trend of the e-mail protected by the user is learned based on a variety of information stored on the related information storage unit 152.

The cellular terminal device 100 identifies the senders of the e-mails more important for the user based on the variety of information stored on the related information storage unit 152. The user is more likely to protect the e-mail received from the sender “C,” and the e-mail received from the sender “C” is considered to be an important e-mail for the user of the cellular terminal device 100.

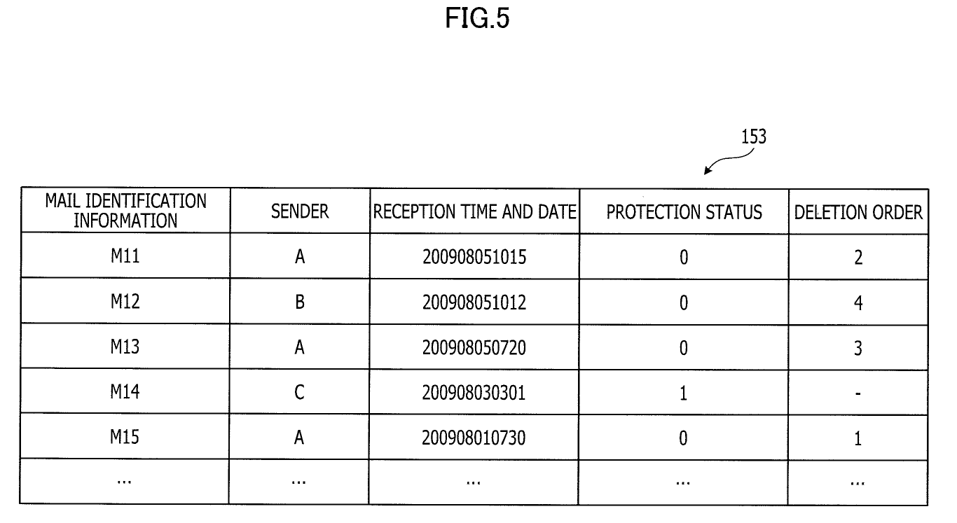

The received mail storage unit 153 stores the received e-mail. The received mail storage unit 153 may also be referred to as a received mail box. FIG. 5 illustrates an example of the received mail storage unit 153. Referring to FIG. 5, the received mail storage unit 153 of an embodiment stores items such as “mail identification information,” “sender,” “reception time and date,” “protection status,” and “deletion order.” The received mail storage unit 153 may also store header information of an e-mail, and data of a body of the e-mail, although not illustrated in FIG. 5.

The “mail identification information” identifies an e-mail. The “sender” stores sender information of an e-mail identified by the “mail identification information.” The “reception time and date” indicates time and date of reception of the e-mail identified by the “mail identification information.” The “protection status” indicates whether the e-mail identified by the “mail identification information” is protected by the user or not. If the “protection status” is “0” in FIG. 5, the e-mail is not protected, and if the “protection status” is “1,” the e-mail is protected.

The “deletion order” indicates a deletion order of a plurality of e-mails stored on the received mail storage unit 153. In accordance with an embodiment, an e-mail having a smaller value for the “deletion order” is deleted with a higher priority. The “deletion order” is updated by the deletion order determiner 163 to be discussed later. The “deletion order” is also described later in the discussion of the deletion order determiner 163.

A first row of the received mail storage unit 153 in FIG. 5 indicates that the sender of the e-mail identified by the mail identification information “M11” is “A” and that the time and date of reception of the e-mail is 10:15, Aug. 5, 2009, and that the e-mail is not protected. A second row of the received mail storage unit 153 in FIG. 5 indicates that the sender of the e-mail identified by the mail identification information “M12” is “B” and that the time and date of reception of the e-mail is 10:12, Aug. 5, 2009, and that the e-mail is not protected.

The controller 160 includes an internal memory storing a program defining a variety of calculation processes, and executes the variety of calculation processes. Referring to FIG. 2, the controller 160 includes an operation trend information gatherer 161, a related information gatherer 162, a deletion order determiner 163, a deletion processor 164, and a storage control unit 165.

The operation trend information gatherer 161 gathers operation trend information, and stores the gathered operation trend information onto the operation trend information storage unit 151. More specifically, if an e-mail is deleted from the received mail storage unit 153 by the user, the operation trend information gatherer 161 of an embodiment calculates a period throughout which the e-mail was stored on the received mail storage unit 153. The operation trend information gatherer 161 then increments the storage period on the operation trend information storage unit 151 in response to the calculated period.

For example, the user may now delete an e-mail that has elapsed 5 minutes since the storage thereof on the received mail storage unit 153. In other words, the user deletes the e-mail 5 minutes after the reception of the e-mail by the cellular terminal device 100. The operation trend information gatherer 161 increments a value stored at the storage period “shorter than 10 minutes” on the operation trend information storage unit 151. For example, if “10” is stored at the storage period “shorter than 10 minutes” on the operation trend information storage unit 151 as illustrated in FIG. 3, “10” stored at the storage period “shorter than 10 minutes” is updated to “11.”

The user may delete an e-mail that has elapsed 3 hours since the storage thereof on the received mail storage unit 153. The operation trend information gatherer 161 increments a value stored at the storage period “10 minutes or longer and shorter than 1 day” on the operation trend information storage unit 151. The user may delete an e-mail that has elapsed 2 days since the storage thereof on the received mail storage unit 153. The operation trend information gatherer 161 increments a value stored at the storage period “1 day or longer” on the operation trend information storage unit 151.

The related information gatherer 162 gathers related information, and stores the gather related information on the related information storage unit 152. The related information gatherer 162 of an embodiment includes a received mail checking unit 162a and a manual protection information gathering unit 162b.

The received mail checking unit 162a updates the total reception count on the related information storage unit 152. More specifically, the received mail checking unit 162a increments the total reception count on the related information storage unit 152 corresponding to the sender of an e-mail if the e-mail is received.

The related information storage unit 152 may now be in the state illustrated in FIG. 4. If an e-mail is received from the sender “A,” the received mail checking unit 162a updates the total reception count on the related information storage unit 152 corresponding to the sender “A” from “50” to “51.” If an e-mail is received from the sender “B,” the received mail checking unit 162a updates the total reception count on the related information storage unit 152 corresponding to the sender “B” from “30” to “31.”

The manual protection information gathering unit 162b updates the protected mail count on the related information storage unit 152. More specifically, if an e-mail is protected by the user, the manual protection information gathering unit 162b increments the protected mail count on the related information storage unit 152 corresponding to the sender of the protected e-mail.

The related information storage unit 152 may now be in the state illustrated in FIG. 4. If the user protects an e-mail from the sender “A,” the manual protection information gathering unit 162b updates the protected mail count on the related information storage unit 152 corresponding to the sender “A” from “0” to “1.” If the user protects an e-mail from the sender “B,” the manual protection information gathering unit 162b updates the protected mail count on the related information storage unit 152 corresponding to the sender “B” from “3” to “4.”

The deletion order determiner 163 determines a deletion order of a plurality of e-mails stored on the received mail storage unit 153, in accordance with a variety of information stored on the operation trend information storage unit 151 and a variety of information stored on the related information storage unit 152. More specifically, the deletion order determiner 163 updates the deletion point on the related information storage unit 152. The deletion order determiner 163 attaches the deletion point to each e-mail in the received mail storage unit 153, in accordance with the operation trend information stored on the operation trend information storage unit 151 and the deletion point on the related information storage unit 152. In accordance with the attached deletion point, the deletion order determiner 163 determines the deletion order of each e-mail stored on the received mail storage unit 153.

The deletion order determination process of the deletion order determiner 163 is described below with reference to FIGS. 3-5. In the discussion that follows, the operation trend information storage unit 151 is in the state illustrated in FIG. 3, the related information storage unit 152 is in the state illustrated in FIG. 4, and the received mail storage unit 153 is in the state illustrated in FIG. 5.

The deletion order determiner 163 calculates a ratio of the protected mail count to the total reception count (hereinafter referred to a “protection ratio”) on a per sender basis in accordance with the variety of information stored the related information storage unit 152.

More specifically, as illustrated in FIG. 4, the protected mail count for the sender “A” is “0,” and the deletion order determiner 163 calculates the protection ratio of the sender “A,” thereby obtaining “0%.” Referring to FIG. 4, the total reception count for the sender “B” is “30,” and the protected mail count is “3.” The deletion order determiner 163 divides the protected mail count “3” by the total reception count “30” to calculate the protection ratio of the sender “B,” thereby obtaining “0.1.” Referring to FIG. 4, the total reception count for the sender “C” is “10,” and the protected mail count is “2.” The deletion order determiner 163 divides the protected mail count “2” by the total reception count “10” to calculate the protection ratio of the sender “C,” thereby obtaining “0.2.” The deletion order determiner 163 thus calculates the protection ratio for each sender as follows:
(a). Sender “A”: Protection ratio “0%”
(b). Sender “B”: Protection ratio “10%”
(c). Sender “C”: Protection ratio “20%”

From among the e-mails received from the senders A, B and C (A-C), the user of the cellular terminal device 100 is most likely to protect an e-mail received from the sender C, and more likely to protect an e-mail received from the sender B. In other words, the e-mail received from the sender C is the most important for the user of the cellular terminal device 100.

The higher the protection ratio, the lower deletion point the deletion order determiner 163 sets, and the lower the protection ratio, the higher deletion point the deletion order determiner 163 sets. The deletion points for the protection ratios are determined as listed below:
(a). Protection ratio 0%: Deletion point “+5”
(b). Protection ratio 1%-10%: Deletion point “+3”
(c). Protection ratio 11%-50%: Deletion point “+2”
(d). Protection ratio 51%-100%: Deletion point “+1”

Since the protection ratio for the sender “A” is “0%,” the deletion order determiner 163 updates the deletion point for the sender “A” to “5,” as illustrated in FIG. 4. Since the protection ratio for the sender “B” is “10%,” the deletion order determiner 163 updates the deletion point for the sender “B” to “3.” Since the protection ratio for the sender “C” is “20%,” the deletion order determiner 163 updates the deletion point for the sender “C” to “2.”

The deletion order determiner 163 calculates a ratio of the number of e-mails deleted during a specific storage period to the total number of e-mails deleted by the user (hereinafter referred to as a “storage period based deletion ratio”).

More specifically, the deletion order determiner 163 sums “10,” “5,” and “20” stored at the storage periods on the operation trend information storage unit 151, thereby resulting in “35” as the total number of e-mails deleted by the user. The deletion order determiner 163 then divides the total number of e-mails “10” deleted during the storage period “shorter than 10 minutes” by the total number “35,” thereby resulting in “0.29” as the storage period based deletion ratio of the storage period “shorter than 10 minutes.” The deletion order determiner 163 then divides the total number of e-mails “5” deleted during the storage period “10 minutes or longer and shorter than 1 day” by the total number “35,” thereby resulting in “0.14” as the storage period based deletion ratio of the storage period “10 minutes or longer and shorter than 1 day.” The deletion order determiner 163 then divides the total number of e-mails “20” deleted during the storage period “longer than 1 day” by the total number “35,” thereby resulting in “0.57” as the storage period based deletion ratio of the storage period “longer than 1 day.” In the above example, the deletion order determiner 163 rounds the division results to the nearest hundredth. In summary, the deletion order determiner 163 calculates the protection ratio for each sender as listed below:
(a). Storage period “shorter than 10 minutes”:
   Storage period based deletion ratio “29%”
(b). Storage period “10 minutes or longer and shorter than 1 day”:
   Storage period based deletion ratio “14%”
(c). Storage period “longer than 1 day”:
   Storage period based deletion ratio “57%”

From the above listing, the user of the cellular terminal device 100 is less likely to protect an e-mail having a storage period “10 minutes or longer and shorter than 1 day”, and more likely to protect an e-mail having a storage period “longer than 1 day.”

To attach the deletion point to an e-mail stored on the received mail storage unit 153, the deletion order determiner 163 calculates a period from the storage of the e-mail on the received mail storage unit 153 to the present time. The higher the storage period based deletion ratio responsive to the calculated period, the higher deletion point the deletion order determiner 163 thus attaches to the e-mail. The lower the storage period based deletion ratio responsive to the calculated period, the lower deletion point the deletion order determiner 163 thus attaches to the e-mail. The deletion point is determined to the storage period based deletion ratio as listed below:
(a). Storage period based deletion ratio 0%-20%:
   Deletion point “+0”
(b). Storage period based deletion ratio 21%-50%:
   Deletion point “+1”
(c). Storage period based deletion ratio 51%-100%:
   Deletion point “+3”

In such a case, the deletion order determiner 163 adds a deletion point of “1” to an e-mail having a storage period “shorter than 10 minutes” from the storage thereof on the received mail storage unit 153 to the present time. The deletion order determiner 163 adds no deletion point to an e-mail having a storage period “10 minutes or longer and shorter than 1 day” from the storage thereof on the received mail storage unit 153 to the present time. The deletion order determiner 163 adds a deletion point of “3” to an e-mail having a storage period “longer than 1 day” from the storage thereof on the received mail storage unit 153 to the present time.

The received mail storage unit 153 illustrated in FIG. 5 is described below. The present time here is “200908051020.” The deletion order determiner 163 retrieves from the received mail storage unit 153 illustrated in FIG. 5 information about the sender “A” corresponding to the mail identification information “M11” and the reception time and date “200908051015.” The deletion order determiner 163 retrieves a deletion point of “5” corresponding to the sender “A” from the related information storage unit 152. The deletion order determiner 163 attaches a deletion point of “5” to the e-mail identified by the mail identification information “M11.”

The deletion order determiner 163 calculates a storage period of the e-mail stored on the received mail storage unit 153 and identified the mail identification information “M11.” Since the present time is “200908051020” and the reception time and date of the e-mail identified by the mail identification information “M11” is “200908051015,” the deletion order determiner 163 results in a storage time of “5 minutes” by calculating a difference between the present time and the reception time and date. Since the storage time of “5 minutes” is “shorter than 10 minutes,” the deletion order determiner 163 adds a deletion point of “1” to the e-mail identified by the mail identification information “M11.” More specifically, the deletion order determiner 163 attaches a deletion point of “5+1”=“6” to the e-mail identified by the mail identification information “M11.”

The deletion order determiner 163 performs the above-described process to each e-mail stored on the received mail storage unit 153. As a result, the deletion order determiner 163 attaches the following deletion points to the e-mails identified by the mail identification information “M11”-“M15.”
(a). Mail identification information “M11”:
   Deletion point “5+1”=“6”
(b). Mail identification information “M12”:
   Deletion point “3+1”=“4”
(c). Mail identification information “M13”:
   Deletion point “5+0”=“5”
(d). Mail identification information “M14”:
   Deletion point “2+3”=“5”
(e). Mail identification information “M15”:
   Deletion point “5+3”=“8”

As a larger deletion point is attached to an e-mail, the deletion order determiner 163 sets a smaller deletion order to that e-mail. For example, the received mail storage unit 153 may now store only five e-mails identified by the mail identification information “M11”-“M15,” as illustrated in FIG. 5. The deletion order determiner 163 sets a deletion order “1” to the e-mail identified by the mail identification information “M15” having the highest deletion point. The deletion order determiner 163 sets a deletion order “2” to the e-mail identified by the mail identification information “M11” having the second highest deletion point. The deletion order determiner 163 sets a deletion order “3” to the e-mail identified by the mail identification information “M13” having the third highest deletion point. The deletion order determiner 163 sets a deletion order “4” to the e-mail identified by the mail identification information “M12” having the fourth highest deletion point. The deletion order determiner 163 sets no deletion order to the e-mail identified by the mail identification information “M14” having a protection status of “1.”

The deletion order determiner 163 determines in this way the deletion order of each e-mail stored on the received mail storage unit 153. As previously described, the deletion order determiner 163 determines the deletion order based on the operation trend information indicating the operation trend of the user and the related information indicating the importance of each mail. More specifically, the deletion order determiner 163 can determine the deletion order of the e-mails in the order of high to low likeliness of the e-mail becoming unnecessary for the user.

In order to receive a new e-mail, the deletion processor 164 deletes the e-mails stored on the received mail storage unit 153 in the deletion order determined by the deletion order determiner 163. More specifically, if no memory space is available on the received mail storage unit 153, the deletion processor 164 deletes e-mails from the received mail storage unit 153 in the deletion order determined by the deletion order determiner 163. Two examples of the deletion process of the deletion processor 164 are described below.

When a new e-mail is received, the deletion processor 164 retrieves, from header information or the like, information about a size of the e-mail to be received. If a memory space available on the received mail storage unit 153 is smaller than the size of the e-mail to be received, the received mail storage unit 153 deletes an e-mail having the smallest value in the deletion order stored on the received mail storage unit 153. The deletion processor 164 deletes e-mails having the smallest values in the deletion order stored on the received mail storage unit 153 until the memory space available on the received mail storage unit 153 becomes larger than the size of the e-mail to be received.

Alternatively, in order to receive a new e-mail, the deletion processor 164 determines whether the number of received e-mails stored on the received mail storage unit 153 has reached a specific number. The “specific number” is a given number and represents a maximum number of e-mails the cellular terminal device 100 can store. If the number of received e-mails stored on the received mail storage unit 153 reaches the specific number, the deletion processor 164 deletes an e-mail having the smaller number in the deletion order stored on the received mail storage unit 153.

The storage control unit 165 stores a newly received e-mail on the received mail storage unit 153 after the deletion processor 164 deletes the e-mail.

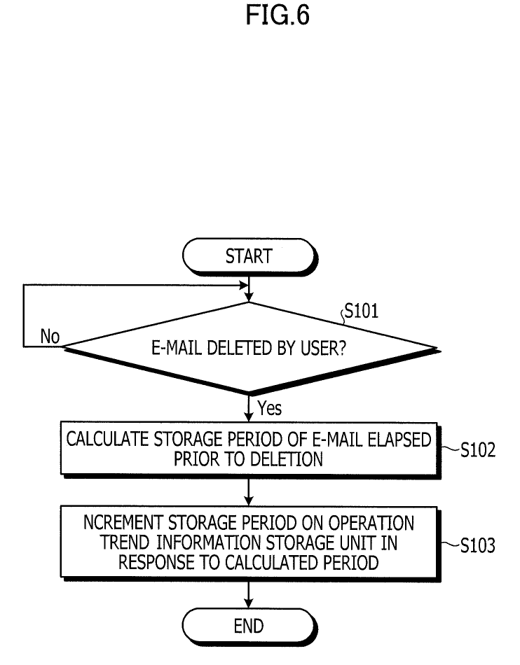

((Process of the Cellular Terminal Device 100 of an Embodiment)) A process of the cellular terminal device 100 of an embodiment is described with reference to FIGS. 6-10.

An operation trend information gathering process of the operation trend information gatherer 161 illustrated in FIG. 2 is described below with reference to FIG. 6. FIG. 6 is a flowchart illustrating the operation trend information gathering process of the operation trend information gatherer 161 of FIG. 2. Referring to FIG. 6, if an e-mail is deleted from the received mail storage unit 153 by the user (yes branch from operation S101), the operation trend information gatherer 161 calculates the storage period of the deleted e-mail (operation S102). For example, the operation trend information gatherer 161 calculates the storage period of the e-mail by determining a difference between the present time and the reception time and date of the deleted e-mail.

The operation trend information gatherer 161 increments the storage period on the operation trend information storage unit 151 in response to the storage period calculated in operation S102 (operation S103). For example, if the storage period of the e-mail deleted by the user is “5 minutes,” the operation trend information gatherer 161 increments the value stored on the storage period “shorter than 10 minutes” on the operation trend information storage unit 151 illustrated in FIG. 3.

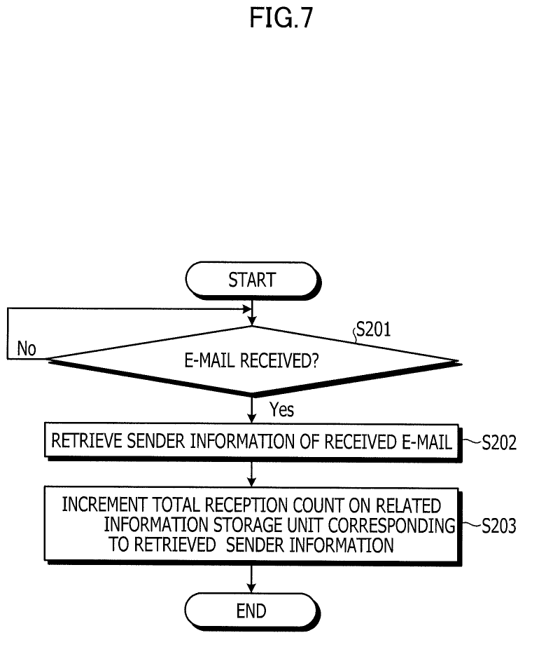

Referring to FIG. 7, a mail checking process of the received mail checking unit 162a illustrated in FIG. 2 is described in detail below. FIG. 7 is a flowchart of the mail checking process performed by the received mail checking unit 162a illustrated in FIG. 2. An e-mail is received as illustrated in FIG. 7 (yes branch from operation S201), the received mail checking unit 162a retrieves sender information of the received e-mail (operation S202). For example, the received mail checking unit 162a retrieves a mail address of a transmission source as the sender information from header information or the like of the received e-mail.

The received mail checking unit 162a increments the total reception count on the related information storage unit 152 in response to the sender information retrieved in operation S202 (operation S203). For example, if an e-mail is received from the sender “A,” the received mail checking unit 162a increments a value at the total reception count on the related information storage unit 152 for the sender “A.”

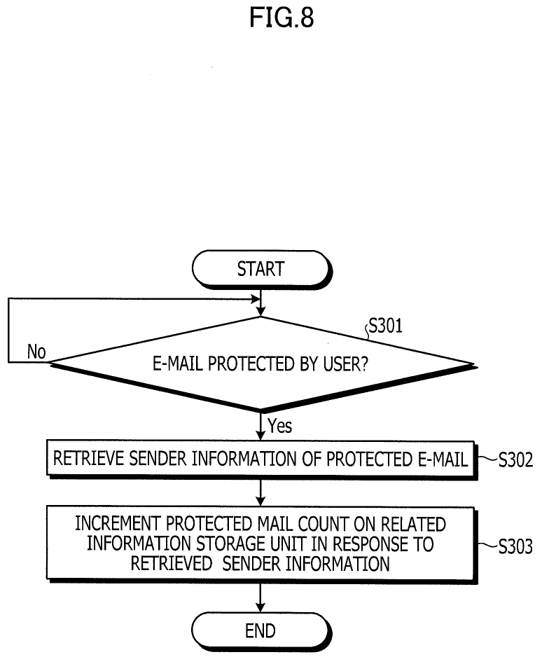

Referring to FIG. 8, a manual protection information gathering process of the manual protection information gathering unit 162b illustrated in FIG. 2 is described below. FIG. 8 is a flowchart illustrating the manual protection information gathering process of the manual protection information gathering unit 162b of FIG. 2. Referring to FIG. 8, if an e-mail is protected by the user (yes branch from operation S301), the manual protection information gathering unit 162b retrieves the sender information of the protected e-mail (operation S302). For example, the manual protection information gathering unit 162b retrieves the sender information of the protected e-mail from information stored at the sender on the received mail storage unit 153.

The manual protection information gathering unit 162b increments the protected mail count on the related information storage unit 152 in response to the sender information retrieved in operation S302 (operation S303). For example, the e-mail corresponding to the mail identification information “M14” out of the e-mails stored on the received mail storage unit 153 illustrated in FIG. 5 is an e-mail protected by the user. In such a case, the manual protection information gathering unit 162b retrieves information of the sender “C” corresponding to the mail identification information “M14.” The manual protection information gathering unit 162b increments the value stored at the protected mail count on the related information storage unit 152 in response to the retrieved information of the sender “C.”

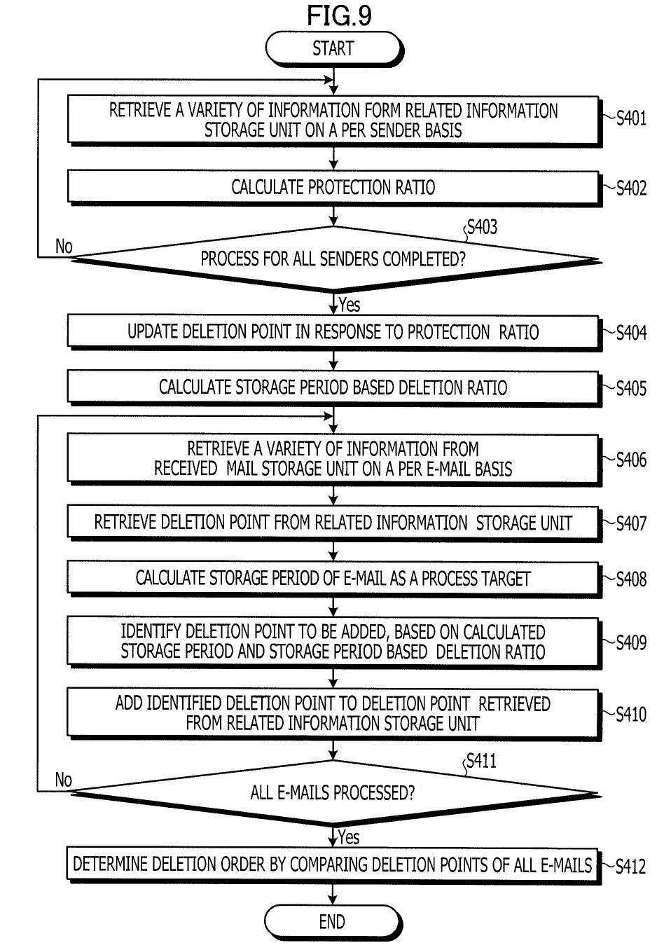

Referring to FIG. 9, a deletion order determination process of the deletion order determiner 163 of FIG. 2 is described below. FIG. 9 is a flowchart illustrating the deletion order determination process of the deletion order determiner 163 illustrated in FIG. 2. Referring to FIG. 9, the deletion order determiner 163 retrieves from the related information storage unit 152 information stored at the “total reception count,” and the “protected mail count” on a per sender basis (operation S401). For example, the deletion order determiner 163 retrieves form the related information storage unit 152 a total reception count “50” and a protected mail count “0” for the sender “A.”

The deletion order determiner 163 then calculates the protection ratio based on the “total reception count” and the “protected mail count” retrieved in operation S401 (operation S402). For example, the deletion order determiner 163 may retrieve the protection ratio based on a total reception count “50” and a protected mail count “0” for the sender “A” in operation S401. The deletion order determiner 163 thus results in “0%” as the protection ratio for the sender “A.” For example, the deletion order determiner 163 may retrieve the protection ratio based on a total reception count “30” and a protected mail count “3” for the sender “B” in operation S401. The deletion order determiner 163 thus results in “10%” as the protection ratio for the sender “B.”

If the protection ratio calculation of all the senders with information related to the senders stored on the related information storage unit 152 is not completed (no branch from operation S403), the deletion order determiner 163 performs the protection ratio calculation in operations S401 and S402 for a remaining sender.

If the protection ratio calculation of all the senders with the information related to the senders stored on the related information storage unit 152 is completed (yes branch from operation S403), the deletion order determiner 163 updates the deletion point on the related information storage unit 152 for the protection ratio (operation S404). More specifically, the deletion order determiner 163 sets a smaller value for the deletion point as the protection ratio is higher, and sets a larger value for the deletion point as the protection ratio is lower.

The deletion order determiner 163 calculates the storage period based deletion ratio based on the variety of information stored on the operation trend information storage unit 151 (operation S405). The deletion order determiner 163 retrieves from the received mail storage unit 153 the information stored at the “sender” and the “reception time and date” for each e-mail (operation S406). The deletion order determiner 163 retrieves the deletion point corresponding to the “sender” retrieved in operation S405 (operation S407).

The deletion order determiner 163 calculates the storage period of the e-mail as a process target on the received mail storage unit 153, based on the present time and the “reception time and date” retrieved in operation S406 (operation S408). The deletion order determiner 163 determines the deletion point, based on the calculated storage period and the storage period based deletion ratio calculated in operation S405 (operation S409). The deletion order determiner 163 then sums the deletion point retrieved in operation S407 and the deletion point determined in operation S409, and attaches the point sum to the e-mail as the process target (operation S410).

If the deletion point attachment process is not completed for all the e-mails stored on the received mail storage unit 153 (no branch from operation S411), the deletion order determiner 163 performs the process operations in operations S406-S410 for an unprocessed e-mail.

If the deletion point attachment process is completed for all the e-mails stored on the received mail storage unit 153 (yes branch from operation S411), the deletion order determiner 163 determines the deletion order of the e-mails (operation S412). More specifically, the deletion order determiner 163 determines the deletion order of each e-mail based on the deletion points provided in operation S411.

The deletion order determiner 163 periodically performs the deletion order determination process. For example, the deletion order determiner 163 performs the deletion order determination process every few hours or every day. Alternatively, the deletion order determiner 163 may perform the deletion order determination process when the cellular terminal device 100 is not used by the user. Alternatively, the deletion order determiner 163 may perform the deletion order determination process in a time band throughout which the user is less likely to use the cellular terminal device 100.

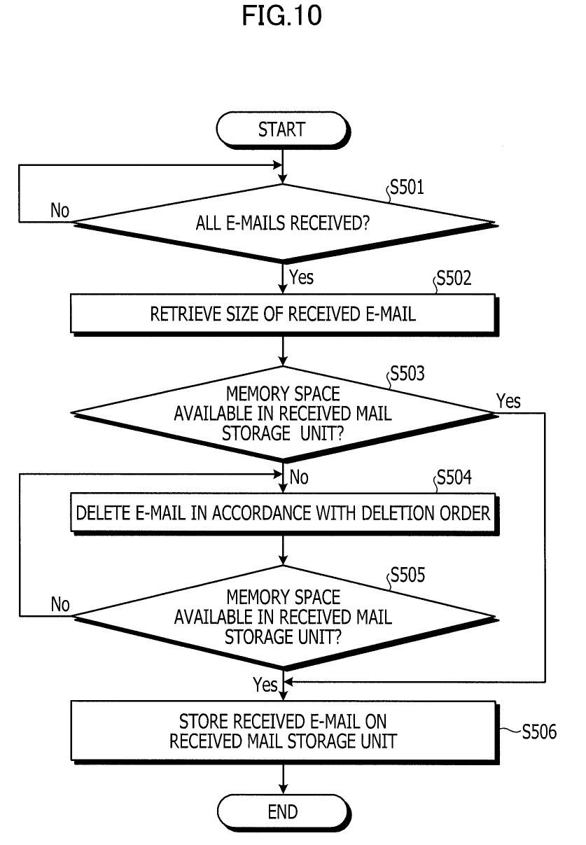

Referring to FIG. 10, a deletion process of the deletion processor 164 of FIG. 2 is described. FIG. 10 is a flowchart of the deletion process of the deletion processor 164 illustrated in FIG. 2. Referring to FIG. 10, if a new e-mail is received (yes branch from operation S501), the deletion processor 164 retrieves information of a size of the received e-mail (operation S502).

If a memory space is available on the received mail storage unit 153 (yes branch from operation S503), the deletion processor 164 ends the process. If no memory space is available on the received mail storage unit 153 (no branch from operation S503), the deletion processor 164 deletes e-mails from the received mail storage unit 153 in accordance with the information stored at the deletion order on the received mail storage unit 153 (operation S504). More specifically, the deletion processor 164 deletes an e-mail having the smallest value at the deletion order on the received mail storage unit 153.

If no memory space is available on the received mail storage unit 153 even with the e-mail deleted (no branch from operation S505), the deletion processor 164 performs operation S504 again. If a memory space is available on the received mail storage unit 153 (yes branch from operation S505), the deletion processor 164 ends the process.

Subsequent to the deletion process of the deletion processor 164, the storage control unit 165 stores on the received mail storage unit 153 the e-mail received in operation S501 (operation S506).

As described above, the cellular terminal device 100 of an embodiment gathers the operation trend information indicating the operation trend of the user, and determines the deletion order of the e-mail in accordance with the gathered operation trend information. The cellular terminal device 100 of an embodiment deletes, with a higher priority, the e-mail likely to be deleted by the user.

The cellular terminal device 100 of an embodiment gathers the related information indicating the importance of each e-mail stored on the received mail storage unit 153, and determines the deletion order in accordance with the gathered related information. The cellular terminal device 100 of an embodiment can delete, with a higher priority, an e-mail less important for the user.

Each time an e-mail deletion operation is performed by the user, the cellular terminal device 100 of an embodiment gathers an operation trend information and the related information. Each time an e-mail deletion operation is performed, the cellular terminal device 100 of an embodiment can update the deletion order of the e-mails. More specifically, the cellular terminal device 100 of an embodiment can dynamically detect an e-mail likely to become unnecessary for the user. According to an embodiment a setting of a deletion order is automatically implemented without requiring input of a user specifying the deletion order.

The cellular terminal device 100 of an embodiment gathers the operation trend information and the related information based on an operation history of the user. With the cellular terminal device 100 of an embodiment, the user can save them time for inputting information used to determine the deletion priority of the e-mail.

The cellular terminal device 100 of an embodiment can delete efficiently an e-mail likely to become unnecessary for the user without the user being conscious of an e-mail as an automatic deletion target.

In accordance with an embodiment, a storage period is used as the operation trend information and the protected mail count or the protection ratio is used as the related information as illustrated in FIGS. 3 and 4. The cellular terminal device disclosed in the application may use other information as the operation trend information and the related information. In accordance with an embodiment, other information is used as the operation trend information and the related information.

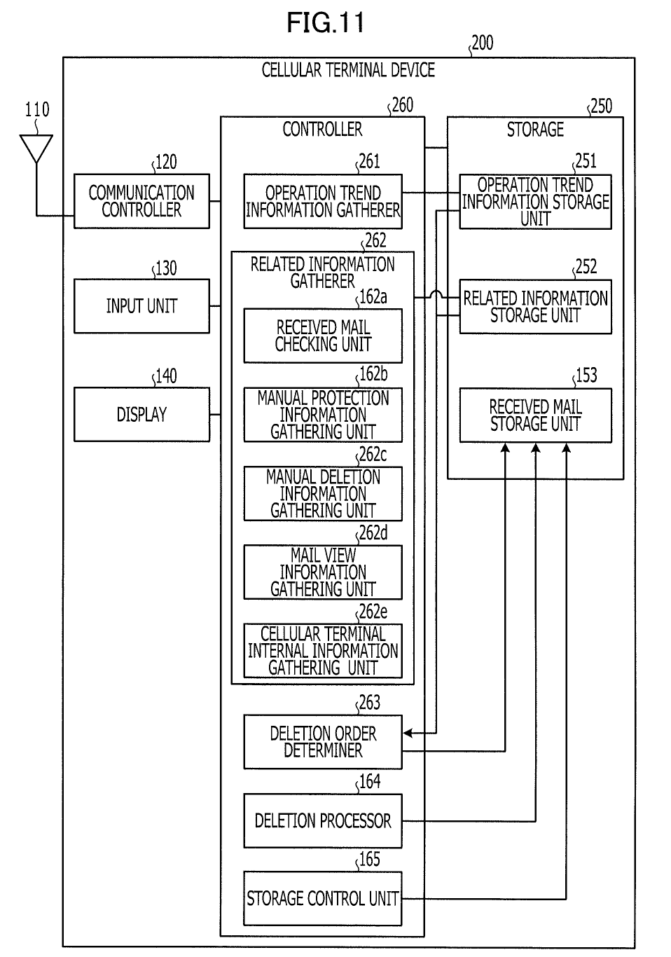

((Structure of Cellular Terminal Device of an Embodiment)) A cellular terminal device 200 of an embodiment is described below with reference to FIG. 11. FIG. 11 illustrates a structure of the cellular terminal device 200 of an embodiment. Referring to FIG. 11, the cellular terminal device 200 includes an antenna 110, a communication controller 120, an input unit 130, a display 140, a storage 250, and a controller 260. Elements identical in function to those illustrated in FIG. 2 are designated with the same reference numerals and the detailed discussion thereof is omitted here.

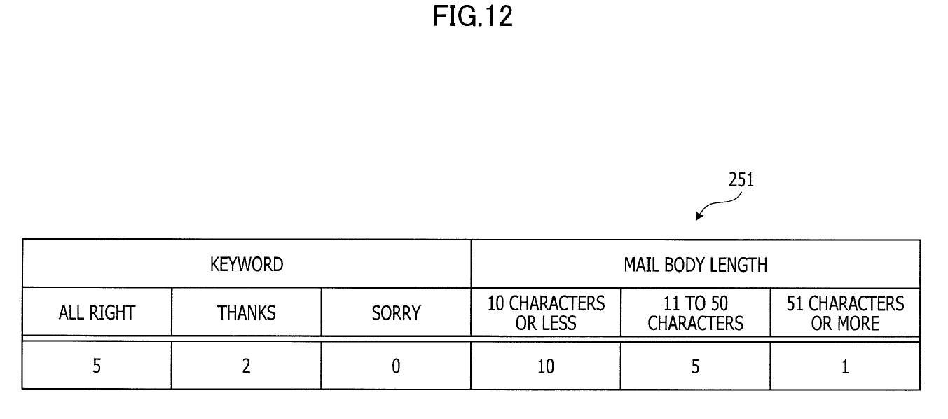

The storage 250 includes an operation trend information storage unit 251, a related information storage unit 252, and a received mail storage unit 153. FIG. 12 illustrates the example of the operation trend information storage unit 251. Referring to FIG. 12, the operation trend information storage unit 251 of an embodiment stores items such as a “keyword,” and a “mail body length.”

The “keyword” represents a number of e-mails deleted by the user, each including a specific character string included in subjects (titles) or mail bodies thereof. The operation trend information storage unit 251 illustrated in FIG. 12 indicates that the number of e-mails, each e-mail including the phrase “all right” in the subject or the mail body thereof, out of the e-mails deleted by the user, is “5.” The operation trend information storage unit 251 illustrated in FIG. 12 indicates that the number of e-mails, each e-mail including the word “thanks” in the subject or the mail body thereof, out of the e-mails deleted by the user, is “2.” The operation trend information storage unit 251 illustrated in FIG. 12 indicates that the number of e-mails, each e-mail including the word “sorry” in the subject or the mail body thereof, out of the e-mails deleted by the user, is “0.”

The “mail body length” represents the total number of e-mails deleted by the user on a per length or size basis of the mail body of the deleted e-mail. The operation trend information storage unit 251 illustrated in FIG. 2 indicates that the number of e-mails having a mail body length of “10 characters or less” out of the e-mails deleted by the user is “10.” The operation trend information storage unit 251 illustrated in FIG. 2 indicates that the number of e-mails having a mail body length of “11 to 50 characters” out of the e-mails deleted by the user is “5.” The operation trend information storage unit 251 illustrated in FIG. 2 indicates that the number of e-mails having a mail body length of “51 characters or more” out of the e-mails deleted by the user is “1.”

With the operation trend information storage unit 251 in the state illustrated in FIG. 12, the user of the cellular terminal device 200 is likely to delete an e-mail including “all right” in the subject or the mail body thereof. With the operation trend information storage unit 251 in the state illustrated in FIG. 12, the user of the cellular terminal device 200 is likely to delete an e-mail having a mail body length “10 characters or less.” The deletion order determiner 263 identifies the trend of the e-mail to be deleted by the user, based on the variety of information stored on the operation trend information storage unit 251.

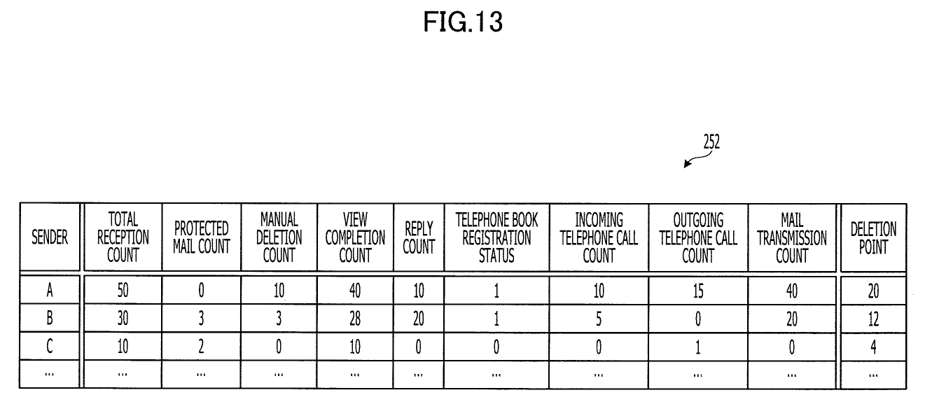

FIG. 13 illustrates an example of the related information storage unit 252. Referring to FIG. 13, the related information storage unit 252 of an embodiment includes new items such as a “manual deletion count,” a “view completion count,” a “reply count,” a “telephone book registration status,” an “incoming telephone call count,” an “outgoing telephone call count,” and a “mail transmission count.”

The “manual deletion count” indicates the number of e-mails deleted by the user, out of the “total reception count.” The “view completion count” indicates the number of e-mails that have been viewed to the last line of the mail body by the user out of the “total reception count.” The “reply count” indicates the number of e-mails that the user has replied to, out of the “total reception count.”

The “telephone book registration status” indicates whether information related to the “sender” is registered in telephone book information. The “telephone book information” here includes a telephone number, a mail address, etc. If the “telephone book registration status” is “0” in FIG. 13, information corresponding to the “sender” is not registered in the telephone book information. If the “telephone book registration status” is “1” in FIG. 13, information corresponding to the “sender” is registered in the telephone book information.

The “incoming telephone call count” indicates the number of incoming telephone calls made by the “sender.” The “outgoing telephone call count” indicates the number of outgoing telephone calls the user has made to the “sender.” The “mail transmission count” indicates the total number of e-mails transmitted to the “sender.”

A first row of the related information storage unit 252 illustrated in FIG. 13 indicates that the number of e-mails received from the sender “A” is “50.” The first row of the related information storage unit 252 illustrated in FIG. 13 indicates that the number of e-mails deleted by the user, out of the 50 e-mails, is “10,” and that the number of e-mails that the user has viewed to the last lines of the mail bodies is “40.” The first row of the related information storage unit 252 illustrated in FIG. 13 indicates that the number of e-mails that the user has replied to, out of the 50 e-mails received from the sender “A”, is “10.” The first row of the related information storage unit 252 illustrated in FIG. 13 indicates that a telephone number and a mail address of the sender “A” are registered in the telephone book information. The first row of the related information storage unit 252 illustrated in FIG. 13 indicates that the number of incoming telephone calls from the sender “A” is “10” and that the number of outgoing telephone calls to the sender “A” is “15.” The first row of the related information storage unit 252 illustrated in FIG. 13 indicates that the total number of e-mails to the sender “A” is “40.”

With the related information storage unit 252 in the state of FIG. 13, the cellular terminal device 200 receives many more e-mails from the sender “A” than e-mails from each of the senders “B” and “C.” However, the user of the cellular terminal device 200 is less likely to delete the e-mails received from the sender “C” than the e-mails received from each of the senders “A” and “B.” The user of the cellular terminal device 200 is more likely to view the e-mail from the sender “C” to the last line of the e-mail than the e-mails from the senders “A” and “B.”

Based on a variety of information stored on the related information storage unit 252, the cellular terminal device 200 may identify the trend of the e-mails important for the user on a per sender basis. In the above example, the user of the cellular terminal device 200 is less likely to delete the e-mails from the sender “C” and more likely to view the e-mails from the sender “C” to the last lines of the e-mails. It is thus considered that the e-mails received from the sender “C” are important for the user of the cellular terminal device 200.

The user of the cellular terminal device 200 does not register information related to the user “C” on the telephone book information. The user receives incoming telephone calls from the sender “C” at a lower frequency than those from each of the senders “A” and “B” and transmits outgoing telephone calls to the sender “C” at a lower frequency than those to the other senders. The user also transmits e-mails to the sender “C” at a lower frequency than those to each of the senders “A” and “B.”

Given these pieces of information, the cellular terminal device 200 may identify a frequency of contacts between the user and the sender of the e-mails based on the variety of information stored on the related information storage unit 252. An e-mail transmitted from a sender having a low frequency of contacts may be considered less important for the user. In the above example, the e-mail received from the sender “C” may be considered less important for the user of the cellular terminal device 200.

The deletion order determiner 263 to be discussed later sets the deletion point on a per sender basis based on the information stored at each item illustrated in FIG. 13. The process of the deletion order determiner 263 is described in detail below.

If an e-mail is deleted from the received mail storage unit 153 by the user, the operation trend information gatherer 261 determines whether a specific keyword is included in the deleted e-mail. If the specific keyword is included in the deleted e-mail, the operation trend information gatherer 261 increments the value stored on the operation trend information storage unit 251 corresponding to the keyword. Also, if the e-mail is deleted from the received mail storage unit 153 by the user, the operation trend information gatherer 261 retrieves a mail body length of the deleted e-mail. The operation trend information gatherer 261 increments the value on the operation trend information storage unit 251 in response to the retrieved mail body length.

The user may delete an e-mail including the phrase “all right” in the mail body and having a mail body length of “8 characters.” In such a case, the operation trend information gatherer 261 increments the value stored at the keyword “all right” on the operation trend information storage unit 251 and the value stored at the mail body length “10 characters or less” on the operation trend information storage unit 251.

The related information gatherer 262 includes a received mail checking unit 162a, a manual protection information gathering unit 162b, a manual deletion information gathering unit 262c, a mail view information gathering unit 262d, and a cellular terminal internal information gathering unit 262e.

The manual deletion information gathering unit 262c updates the manual deletion count on the related information storage unit 252. More specifically, if an e-mail is deleted by the user, the manual deletion information gathering unit 262c retrieves the sender information of the deleted e-mail, and increments the manual deletion count on the related information storage unit 252 in response to the retrieved sender information.

The related information storage unit 252 may be now in the state as illustrated in FIG. 13. If an e-mail from the sender “A” is deleted by the user, the manual deletion information gathering unit 262c updates “10” at the manual deletion count on the related information storage unit 252 corresponding to the sender “A” to “11.”

The mail view information gathering unit 262d updates the view completion count and the reply count on the related information storage unit 252. More specifically, if a received e-mail is viewed to the last line of the mail body by the user, the related information gatherer 262 retrieves the sender information of the e-mail, and increments the view completion count on the related information storage unit 252 in response to the retrieved sender information. For example, if the word “END” indicating the last line of the mail body is displayed on the display 140, the mail view information gathering unit 262d determines that the received e-mail has been viewed to the last line thereof.

If a reply operation is performed on a received e-mail by the user, the mail view information gathering unit 262d retrieves the sender information of the e-mail, and increments the reply count on the related information storage unit 252 in response to the retrieved sender information.

The cellular terminal internal information gathering unit 262e updates the incoming telephone call count, the outgoing telephone call count, and the mail transmission count on the related information storage unit 252. More specifically, the cellular terminal internal information gathering unit 262e sums the incoming telephone call count, the outgoing telephone call count, and the mail transmission count on a per sender basis based on the telephone book information, outgoing telephone call history, incoming telephone call history, etc. The cellular terminal internal information gathering unit 262e updates the incoming telephone call count, the outgoing telephone call count, and the mail transmission count on the related information storage unit 252 in response the sum results.

The deletion order determiner 263 determines a deletion order of a plurality of e-mails stored on the received mail storage unit 153, based on the variety of information stored on the operation trend information storage unit 251 and the variety of information stored on the related information storage unit 252.

More specifically, the deletion order determiner 263 updates the deletion point on the related information storage unit 252. As the deletion order determiner 163 in an embodiment, the deletion order determiner 263 calculates the protection ratio on a per sender basis. The deletion order determiner 263 also calculates a ratio of the manual deletion count to the total reception count (hereinafter referred to as a “deletion ratio”). The deletion order determiner 263 also calculates a ratio of the view completion count to the total reception count (hereinafter referred to as a “view ratio”). The deletion order determiner 263 also calculates a ratio of the reply count to the total reception count (hereinafter referred to as a “reply ratio”).

As the deletion order determiner 163 in an embodiment, the deletion order determiner 263 sets a smaller value to the deletion point as the protection ratio is higher, and sets a larger value to the deletion point as the protection ratio is lower.

The deletion order determiner 263 sets a larger value to the deletion point as the deletion ratio is higher, and sets a smaller value to the deletion point as the deletion ratio is lower. This is because an e-mail transmitted from a sender having a low deletion ratio is considered to be important for the user.

The deletion order determiner 263 sets a smaller value to the deletion point as the view ratio is higher, and sets a larger value to the deletion point as the view ratio is lower. This is because an e-mail transmitted from a sender having a high view ratio is considered to be important for the user.

The deletion order determiner 263 sets a smaller value to the deletion point as the reply ratio is higher, and sets a larger value to the deletion point as the reply ratio is lower. This is because an e-mail transmitted from a sender having a high reply ratio is considered to be important for the user.

The deletion order determiner 263 adds the deletion point to a sender having “0 (not registered)” stored on the telephone book registration status. The deletion order determiner 263 adds no deletion point to a sender having “1 (registered)” stored on the telephone book registration status. This is because an e-mail transmitted from a sender registered on the telephone book information is considered to be important for the user.

If a large value is stored at the incoming telephone call count, the deletion order determiner 263 sets a small value to the corresponding deletion point, and if a small value is stored at the incoming telephone call count, the deletion order determiner 263 sets a large value to the corresponding deletion point. The frequency of contacts with a sender having a high incoming telephone call count is considered to be high, and an e-mail from the sender is thus considered to be important for the user. For the same reason, if a large value is stored at the outgoing telephone call count or the mail transmission count, the deletion order determiner 263 sets a small value to the deletion point, and if a small value is stored at the outgoing telephone call count or the mail transmission count, the deletion order determiner 263 sets a large value to the deletion point.

On the basis of the information stored on the operation trend information storage unit 251, the deletion order determiner 263 calculates a ratio of the number of mails including a specific keyword to the total number of e-mails deleted by the user (hereinafter referred to as a “keyword based deletion ratio”). The deletion order determiner 263 calculates a ratio of the number of e-mails having a mail body length falling within a specific range to the total number of e-mails deleted by the user (hereinafter referred to as a “mail body length based deletion ratio”).

When a deletion point is attached to an e-mail stored on the received mail storage unit 153, the deletion order determiner 263 determines whether a specific keyword is included in the mail body of the e-mail. If a specific keyword is included in the mail body of the e-mail, the deletion order determiner 263 attaches a larger value deletion point to the e-mail as the keyword based deletion ratio responsive to the keyword is higher. Also, when a deletion point is attached to an e-mail stored on the received mail storage unit 153, the deletion order determiner 263 retrieves a mail body length of the e-mail. The deletion order determiner 263 attaches a larger value deletion point to the e-mail as the mail body length based deletion ratio responsive to the retrieved mail body length is higher.

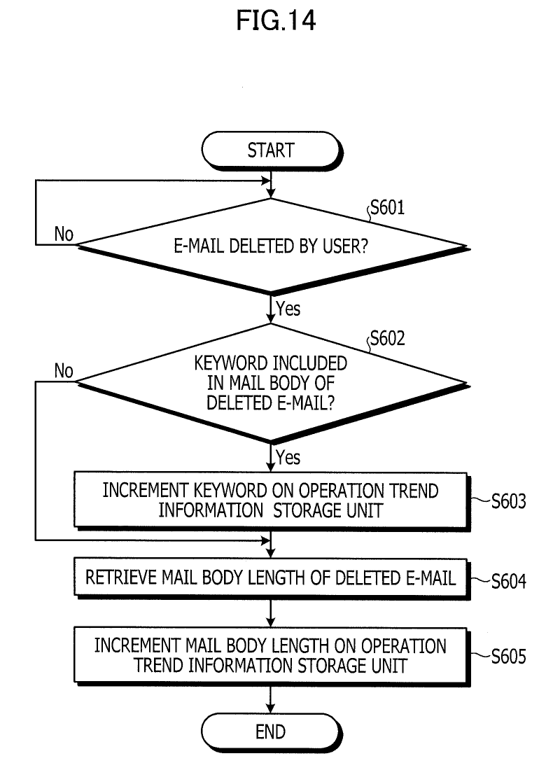

((Process of the Cellular Terminal Device 200 of an Embodiment)) A process of each element of the cellular terminal device 200 of an embodiment is described below with reference to FIGS. 14-17.

Referring to FIG. 14, an operation trend information gathering process of the operation trend information gatherer 261 illustrated in FIG. 11 is described below. FIG. 14 is a flowchart of the operation trend information gathering process of the operation trend information gatherer 261 illustrated in FIG. 11. If an e-mail is deleted from the received mail storage unit 153 by the user (yes branch from operation S601), the operation trend information gatherer 261 determines whether a specific keyword is included in the deleted e-mail (operation S602).

If the specific keyword is included in the deleted e-mail (yes branch from operation S602), the operation trend information gatherer 261 increments the value on the operation trend information storage unit 251 corresponding to the keyword (operation S603).

The operation trend information gatherer 261 retrieves the mail body length of the deleted e-mail (operation S604). The operation trend information gatherer 261 increments the value on the operation trend information storage unit 251 in response to the retrieved mail body length (operation S605).

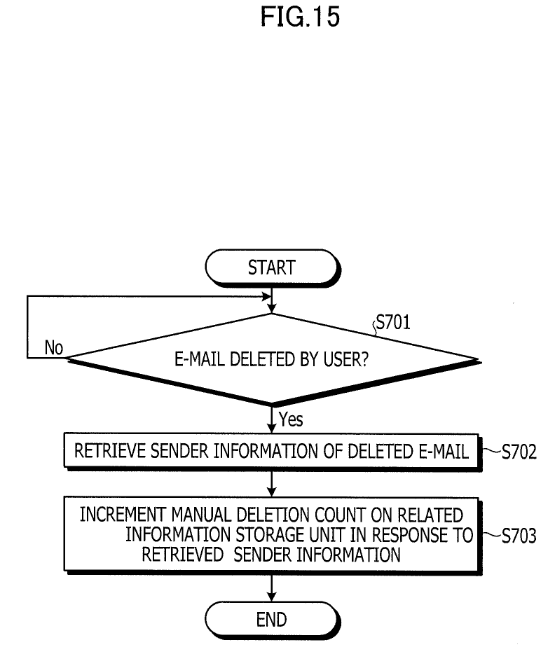

Referring to FIG. 15, a manual deletion information gathering process of the manual deletion information gathering unit 262c illustrated in FIG. 11 is described below. FIG. 15 is a flowchart of the manual deletion information gathering process of the manual deletion information gathering unit 262c illustrated in FIG. 11. If an e-mail is deleted by the user as illustrated in FIG. 15 (yes branch from operation S710), the manual deletion information gathering unit 262c retrieves the sender information of the deleted e-mail (operation S702). The manual deletion information gathering unit 262c increments the manual deletion count on the related information storage unit 252 in response to the retrieved sender information (operation S703).

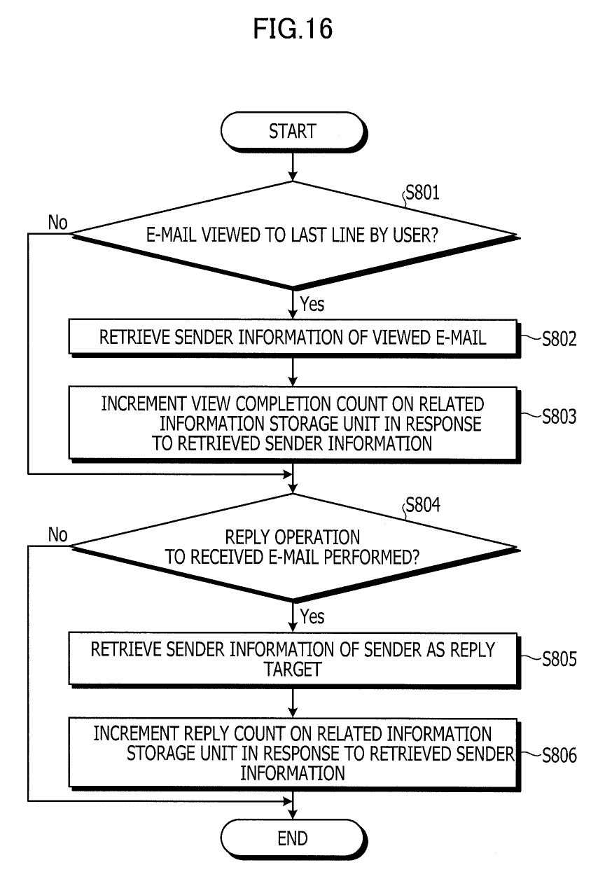

Referring to FIG. 16, a mail view information gathering process of the mail view information gathering unit 262d illustrated in FIG. 11 is described below. FIG. 16 is a flowchart of the mail view information gathering process of the mail view information gathering unit 262d illustrated in FIG. 11. If a received e-mail is viewed to the last line thereof by the user (yes branch from operation S801) as illustrated in FIG. 16, the mail view information gathering unit 262d retrieves the sender information of the e-mail (operation S802). The mail view information gathering unit 262d increments the view completion count on the related information storage unit 252 in response to the retrieved sender information (operation S803).

If a reply operation is performed to the received e-mail by the user (yes branch from operation S804), the mail view information gathering unit 262d retrieves the sender information as a reply destination of the e-mail (operation S805). The mail view information gathering unit 262d increments the reply count on the related information storage unit 252 in response to the retrieved sender information (operation S806).

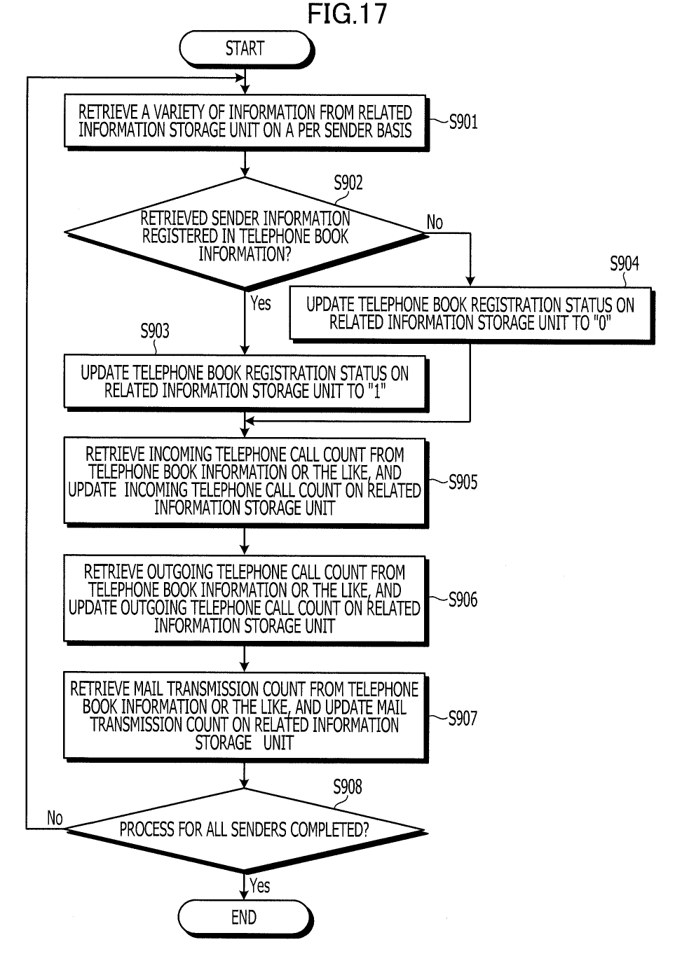

Referring to FIG. 17, a cellular terminal internal information gathering process of the cellular terminal internal information gathering unit 262e illustrated in FIG. 11 is described below. FIG. 17 is a flowchart of the cellular terminal internal information gathering process of the cellular terminal internal information gathering unit 262e illustrated in FIG. 11. As illustrated in FIG. 17, the cellular terminal internal information gathering unit 262e retrieves information stored at the sender on the related information storage unit 252 (operation S901).

The cellular terminal internal information gathering unit 262e determines whether the sender information retrieved in operation S901 is registered in the telephone book information (operation S902). If the sender information is registered in the telephone book information (yes branch from operation S902), the cellular terminal internal information gathering unit 262e updates the telephone book registration status on the related information storage unit 252 corresponding to the sender information to “1 (registered)” (operation S903). If the sender information is not registered in telephone book information (no branch from operation S902), the cellular terminal internal information gathering unit 262e updates the telephone book registration status on the related information storage unit 252 corresponding to the sender information to “0 (not registered)” (operation S904).

The cellular terminal internal information gathering unit 262e sums incoming telephone calls from the sender indicated by the sender information retrieved in operation S901, based on the telephone book information, the incoming call history, and the outgoing call history. The cellular terminal internal information gathering unit 262e updates the incoming telephone call count on the related information storage unit 252 corresponding to the sender information with the call sum.

On the basis of the telephone book information or the like, the cellular terminal internal information gathering unit 262e sums outgoing telephone calls to the sender indicated by the sender information retrieved in operation S901. The cellular terminal internal information gathering unit 262e updates the outgoing telephone call count on the related information storage unit 252 corresponding to the sender information with the call sum (operation S906).

The cellular terminal internal information gathering unit 262e sums the total number of e-mails transmitted to the sender indicated by the sender information retrieved in operation S901. The cellular terminal internal information gathering unit 262e updates the mail transmission count on the related information storage unit 252 corresponding to the sender information with the transmission sum (operation S907).

If the process for all the senders listed on the related information storage unit 252 is not completed (no branch from operation S908), the cellular terminal internal information gathering unit 262e performs operations S901-S907 for a remaining sender. If the process for all the senders listed on the related information storage unit 252 is completed (yes branch from operation S908), the cellular terminal internal information gathering unit 262e ends the process.

As described above, the cellular terminal device 200 of an embodiment gathers the operation trend information and the related information indicating the frequency of contacts between the user and the sender, based on the operation history of the user, the telephone book information, and the like, and then determines the deletion order of the e-mails. The cellular terminal device 200 of an embodiment can thus delete, with a higher priority, the e-mail likely to be deleted by the user. The cellular terminal device 200 of the third embodiment can determine the deletion order of the e-mails based on the frequency of contacts with the user.

The cellular terminal device disclosed in the application may be embodied in an arrangement different from the above-described embodiments. An embodiment of the cellular terminal device is described below.

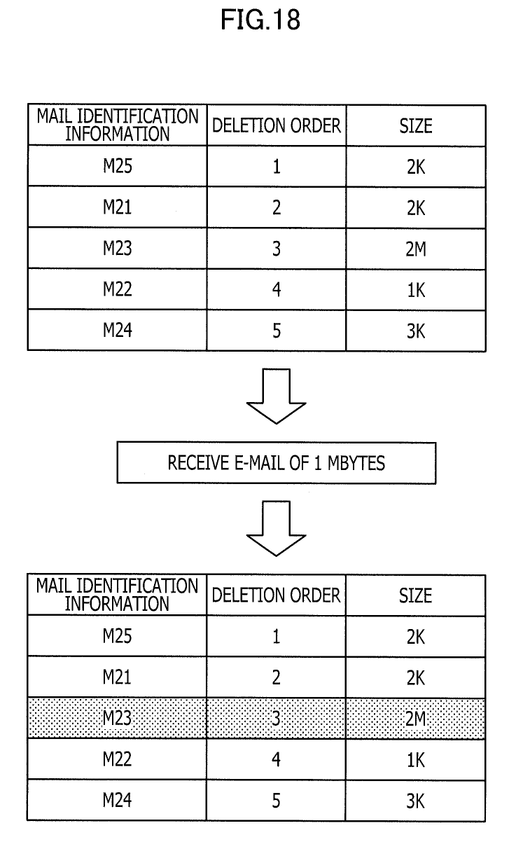

((Deletion Process)) In accordance with at least some of the above-described embodiments, the cellular terminal device deletes the e-mails in accordance with the deletion order. The cellular terminal device disclosed in the application may delete the e-mails, depending on the size of a newly received e-mail, regardless of the deletion order. Such cellular terminal device is described with reference to FIG. 18. FIG. 18 illustrates an example of the e-mail deletion process. The received mail storage unit 153 illustrated in FIG. 18 stores five e-mails respectively identified by mail identification information “M21”-“M25.” The received mail storage unit 153 has now no memory space available.

As illustrated in an upper portion of FIG. 18, the e-mail identified by the mail identification information “M25” has a deletion order “1,” the e-mail identified by the mail identification information “M21” has a deletion order “2,” and the e-mail identified by the mail identification information “M23” has a deletion order of “3.” The e-mails identified by the mail identification information “M25” and the mail identification information “M21” have a size of “2 Kbytes,” and the e-mail identified by the mail identification information “M23” has a size of “2 Mbytes.”

In this condition, an e-mail having a size of “1 Mbytes” is now being received. In accordance with the above-described embodiments, the e-mail identified by the mail identification information “M25” is deleted first. The available memory space on the received mail storage unit 153 is thus increased by “2 Kbytes.” The e-mail identified by the mail identification information “M21” is further deleted in accordance with the above-described embodiments, if a newly received 1 Mbyte e-mail cannot be stored on the received mail storage unit 153. The e-mail identified by the mail identification information “M23” is deleted in accordance with the above-described embodiments if the memory space on the received mail storage unit 153 is still insufficient after the e-mail identified by the mail identification information “M21” is deleted. If the three e-mails identified by the mail identification information “M25,” “M21,” and “M23” are deleted, the space available on the received mail storage unit 153 increases to “2.4 Mbytes,” and the newly received e-mail can be stored on the received mail storage unit 153.

The cellular terminal device of the at least some of above-described embodiments may delete only the e-mail identified by the mail identification information “M23” rather than deleting three e-mails identified by the mail identification information “M25,” “M21,” and “M23.” Through this deletion, the space available on the received mail storage unit 153 increases by “2 Mbytes.” The cellular terminal device of each of the above-described embodiments can store the newly received 1 Mbyte e-mail on the received mail storage unit 153. The cellular terminal device of each of the above-described embodiments may delete only an e-mail larger in size than a newly received e-mail if the e-mail larger in size than the newly received e-mail is included in the e-mails as deletion targets. The cellular terminal device disclosed in the application can thus delay the timing of deletion of the e-mails.

In accordance with at least some of the above-described embodiments, the deletion order of the e-mails is determined in accordance with the varieties of information illustrated in FIGS. 3, 4, 12, and 13. For example, the cellular terminal device 100 of an embodiment determines the deletion order of the e-mails based on the storage period illustrated in FIG. 3, and the protected mail count illustrated in FIG. 4. The cellular terminal device disclosed in the application may determine the deletion order of the e-mails based on other information.

For example, if an e-mail is deleted by the user, the cellular terminal device disclosed in the application may determine whether the deleted e-mail is a Deco mail (registered trademark). The cellular terminal device may then store information indicating whether the Deco mail tends to be deleted. Such an operation, if performed by the cellular terminal device 200 of an embodiment, for example, is described below. The operation trend information gatherer 261 in the cellular terminal device 200 causes the operation trend information storage unit 251 to store the total number of Deco mails. On the basis of the information gathered by the operation trend information gatherer 261, the deletion order determiner 263 in the cellular terminal device 200 adds a deletion point to the Deco mail if the Deco mail is likely to be deleted by the user.

The cellular terminal device disclosed in the application may determine the deletion order of the e-mails on the basis of the total number of unread e-mails, and the number of accesses to a uniform resource locator (URL) included in the mail body. Such an operation, if performed by the cellular terminal device 200 of an embodiment, for example, is described below. The mail view information gathering unit 262d in the cellular terminal device 200 determines whether a received e-mail has been viewed by the user, and causes the related information storage unit 252 to store the number of e-mails unviewed (hereinafter referred to as an “unviewed mail count”). The mail view information gathering unit 262d determines whether the URL included in the mail body of the received e-mail has been accessed, and then causes the related information storage unit 252 to store the number of accessed e-mails. The deletion order determiner 263 in the cellular terminal device 200 sets a larger value to the deletion point as a ratio of the unviewed mail count to the total reception count is higher. For example, the deletion order determiner 263 in the cellular terminal device 200 sets a larger value to the deletion point as a ratio of the number of URL accesses to the total reception count is lower.

The cellular terminal device disclosed in the application may evacuate, to a specific storage area, specific information such as a mail address included in the mail body of a mail to be deleted, a telephone number, and a URL if the e-mail is automatically deleted. The cellular terminal device disclosed in the application may allow the user to view the evacuated specific information.

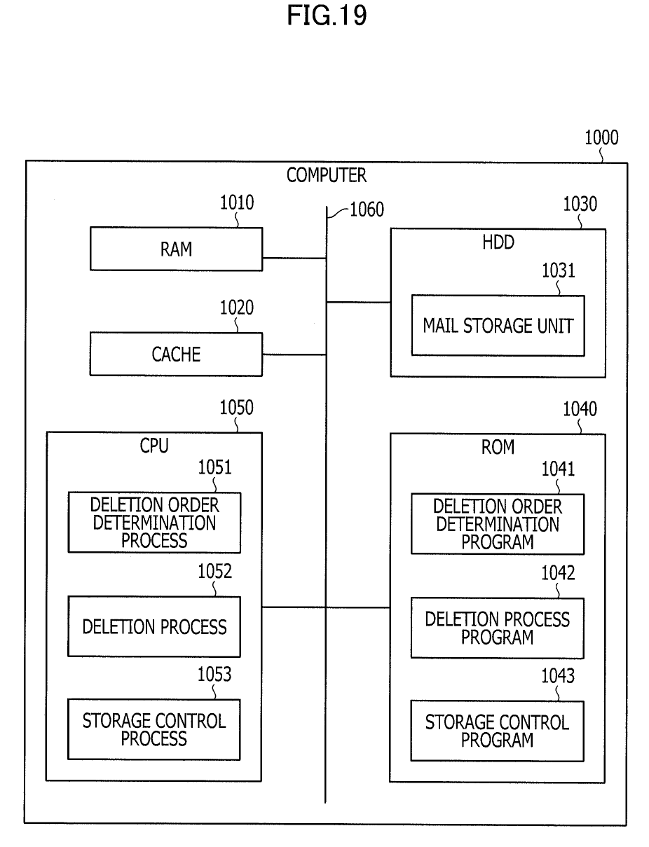

The above-described processes may be performed when a computer, such as a personal computer or a workstation, executes a prepared program. Referring to FIG. 19, a computer 1000 having the same function as that of the cellular terminal device 10 illustrated in FIG. 1 and executing a cellular terminal control program is described below.

According to an embodiment, a condition of a deletion order is automatically adjusted based on trend information pertaining to processing of an email and at least some of emails stored in a memory are deleted based on the deletion order as adjusted. A condition for an order of deleting stored emails is set automatically based on information of processing of emails and without requiring a user to manually specify the order.

FIG. 19 illustrates the computer 1000 executing the cellular terminal control program. Referring to FIG. 19, the computer 1000 includes a random-access memory (RAM) 1010, a cache 1020, a hard disk drive (HDD) 1030, a read-only memory (ROM) 1040, a central processing unit (CPU) 1050, and a bus 1060. The RAM 1010, the cache 1020, the HDD 1030, the ROM 1040, and the CPU 1050 are interconnected to each other via the bus 1060.

The ROM 1040 pre-stores the cellular terminal control program for performing the same function as that of the cellular terminal device 10 illustrated in FIG. 1. More specifically, the ROM 1040 store a deletion order determination program 1041, a deletion process program 1042, and a storage control program 1043.

The CPU 1050 reads and executes the deletion order determination program 1041, the deletion process program 1042, and the storage control program 1043. Referring to FIG. 19, the deletion order determination program 1041 controls a deletion order determination process 1051, the deletion process program 1042 controls a deletion process 1052, and the storage control program 1043 controls a storage control process 1053. The deletion order determination process 1051 corresponds to the deletion order determiner 12 illustrated in FIG. 1, the deletion process 1052 corresponds to the deletion processor 13 illustrated in FIG. 1, and the storage control process 1053 corresponds to the storage controller 14 illustrated in FIG. 1.

The HDD 1030 includes a mail storage unit 1031. The mail storage unit 1031 corresponds to the storage 11 illustrated in FIG. 1.

It is not a requirement that each of the programs 1041-1043 be stored on the ROM 1040. For example, each of the programs 1041-1043 may be stored on a “removable physical medium” loaded onto the computer 1000, such as a flexible disk (FD), a compact-disk ROM (CD-ROM), a magneto-optical (MO) disk, a digital versatile disk (DVD), or an IC card. Each of the programs 1041-1043 may be stored on a “fixed physical medium,” internal to or external to the cellular terminal device 100, such as a hard disk drive (HDD). Each of the programs 1041-1043 may be stored on another “computer (or server)” connected to the cellular terminal device 100 via a public telephone line, the Internet, a local-area network (LAN), or a wide-area network (WAN). The computer 1000 may read the program from the medium, such as the flexible disk, for execution.

As described above, the embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A cellular terminal device, comprising:
a memory for storing a received e-mail;
a deletion order determiner for determining a deletion order of a plurality of e-mails stored on the memory based on an operation of a user or history information related to a mail sender; and
a deletion processor for deleting an e-mail stored on the memory in accordance with the deletion order determined by the deletion order determiner.

2. The cellular terminal device according to claim 1, comprising:
an operation trend information gatherer for gathering operation trend information related to an operation trend of the user using each e-mail stored on the memory, and
wherein the deletion order determiner determines the deletion order of the plurality of e-mails stored on the memory in accordance with the operation trend information gathered by the operation trend information gatherer.

3. The cellular terminal device according to claim 2, wherein the operation trend information gatherer gathers, as the operation trend information, information related to a deletion operation the user has performed on the e-mails stored on the memory.

4. The cellular terminal device according to claim 1, comprising:
a related information gatherer, wherein the related information gatherer gathers, for each of the senders having sent the e-mails stored on the memory, related information indicating importance of each e-mail and/or a frequency of contacts between the user and the sender, and
wherein the deletion order determiner determines the deletion order of the plurality of e-mails stored on the memory in accordance with the related information gathered by the related information gatherer.

5. The cellular terminal device according to claim 1, wherein the deletion processor deletes only an e-mail having a size equal to or larger than a size of a newly received e-mail when e-mails as deletion targets include the e-mail having the size equal to or larger than the size of the newly received e-mail.

6. The cellular terminal device according to claim 1, wherein the deletion processor evacuates, to a specific storage area, a mail address, a telephone number, and a uniform resource locator (URL) included in an e-mail to be deleted.

7. An e-mail deletion method of a cellular terminal device, comprising:
determining a deletion order of a plurality e-mails stored on a memory having stored received e-mails based on an operation of a user or history information related to a mail sender; and
deleting an e-mail stored on the memory in accordance with the determined deletion order.

8. A computer-readable recording medium having stored an e-mail deletion program, the e-mail deletion program comprising:
determining a deletion order of a plurality e-mails stored on a memory having stored received e-mails based on an operation of a user or history information related to a mail sender; and
deleting an e-mail stored on the memory in accordance with the determined deletion order.

9. The computer-readable recording medium according to claim 8, wherein the deletion order is set without requiring manual setting of the deletion order by the user.

10. The computer-readable recording medium according to claim 8, wherein the deletion order is adjusted based on information obtained from a currently received email.
